(19) United States
(12) Patent Application Publication
(10) Pub. No.: US 2023/0316819 A1
(43) Pub. Date: Oct. 5, 2023

(54) CONTROL DEVICE, CONTROL SYSTEM, AND METHOD OF DATA COLLECTION

(71) Applicant: HONDA MOTOR CO., LTD., Tokyo (JP)

(72) Inventors: Kengo Fukuta, Tokyo (JP); Satoshi Kamatani, Tokyo (JP); Tatsuroh Saitoh, Tokyo (JP); Ryuji Ito, Tokyo (JP); Jun Ohashi, Tokyo (JP)

(21) Appl. No.: 18/182,636

(22) Filed: Mar. 13, 2023

(30) Foreign Application Priority Data
Mar. 30, 2022 (JP) 2022-056578

(51) Int. Cl. G07C 5/00; G07C 5/08

(52) U.S. Cl. CPC G07C 5/008; G07C 5/0875

(57) ABSTRACT

A control device mounted on a vehicle includes a designation data acquisition unit that acquires designation data from an external device of the vehicle, the designation data designating vehicle data that is subjected to collection processing, a designation data storage unit that stores the designation data, a vehicle data collection unit that executes the collection processing to collect the vehicle data designated by the designation data, from the vehicle, and a transmission control unit that transmits the vehicle data collected by the vehicle data collection unit, to the external device through a communication device.

### INCORPORATION BY REFERENCE

The present application claims priority under 35 U.S.C. § 119 to Japanese Patent Application No. 2022-056578 filed on Mar. 30, 2022. The content of the application is incorporated herein by reference in its entirety.

### BACKGROUND OF THE INVENTION

### Field of the Invention

The present invention relates to a control device, a control system, and a method of data collection.

### Description of the Related Art

In recent years, with advancement of vehicle functions, it has become possible to acquire various data relating to vehicles. Accordingly, utilization of data relating to vehicles is advancing. For example, proposals have been made that contribute to improving energy efficiency in society, such as mitigating traffic congestion by analyzing data collected from a plurality of vehicles. For example, Japanese Patent Laid-Open No. 2021-196623 discloses a method of outputting information to a vehicle so as to minimize the sum of traffic frequencies on a plurality of roads, by a server collecting past travel data on the vehicle.

Data to be collected from a vehicle may vary depending on the purpose of utilization and the use status of data. In the configuration where a device mounted on a vehicle collects data, as disclosed in Japanese Patent Laid-Open No. 2021-196623, it is necessary to change the behavior of the device mounted on the vehicle in order to change the data to be collected. Since changing the data to be collected may affect the behavior of the vehicle, it is difficult to change the data to be collected easily, and thus there has been a need for a solution to such difficulty in promoting utilization of the data.

An object of the present invention, which has been made in view of such background circumstances, is to make it easy to change target data to be collected, in the case of collecting the data from a vehicle.

### SUMMARY OF THE INVENTION

One aspect for achieving the above object is a control device to be mounted on a vehicle. The control device includes a designation data acquisition unit that acquires designation data from an external device of the vehicle, the designation data designating vehicle data that is subjected to collection processing, a designation data storage unit that stores the designation data, a vehicle data collection unit that executes the collection processing to collect the vehicle data designated by the designation data, from the vehicle, and a transmission control unit that transmits the vehicle data collected by the vehicle data collection unit, to the external device through a communication device.

According to the above configuration, when the control device collects the data relating to a vehicle, the data to be collected is designated by an external device, so that the data to be collected from the vehicle can easily be changed. This makes it possible to efficiently collect necessary data in response to social situations or demands of data. Hence, it is possible to promote utilization of vehicle data and achieve, for example, improvement of energy efficiency.

### BRIEF DESCRIPTION OF THE DRAWINGS

FIG. 1 is a schematic configuration diagram of a control system for a vehicle;

FIG. 2 shows schematic configuration of data management system;

FIG. 3 is a block diagram of a central ECU;

FIG. 4 is a flowchart showing operation of the data management system;

FIG. 5 is a flowchart showing the operation of the data management system;

FIG. 6 is a flowchart showing operation of a central ECU;

FIG. 7 is a flowchart showing the operation of the central ECU;

FIG. 8 is a flowchart showing the operation of the central ECU; and

FIG. 9 is a flowchart showing the operation of the central ECU.

### DETAILED DESCRIPTION OF THE PREFERRED EMBODIMENT

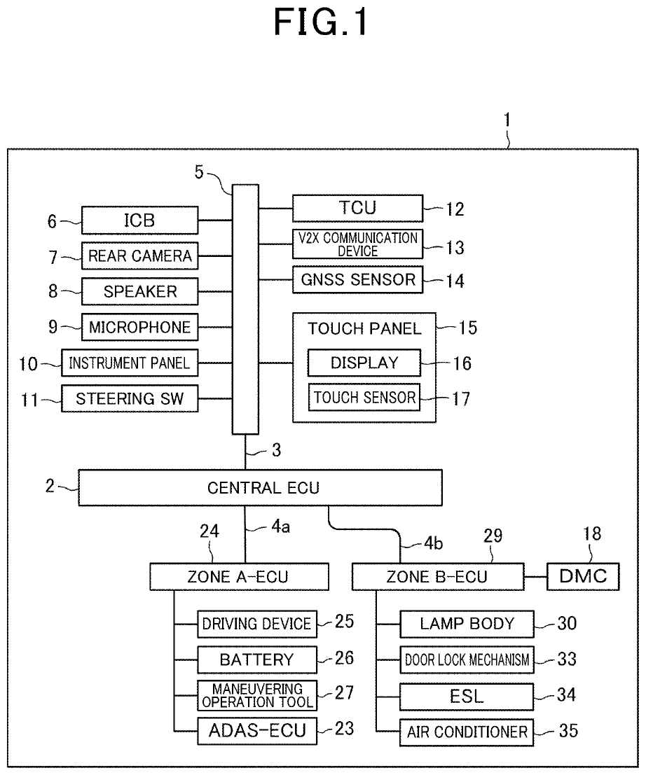

FIG. 1 shows a control system 1 for a vehicle.

The control system 1 includes a central ECU 2 that provides general control and information processing of a vehicle. The central ECU 2 is connected to communication lines including a first communication line 3, and second communication lines 4a and 4b. The central ECU 2 provides the function of a gateway that manages transfer of communication data among these communication lines. The central ECU 2 also executes over the air (OTA) management. The OTA management includes control relating to processing for downloading update programs of in-vehicle devices included in the vehicle, from a server outside the vehicle, and processing for applying the downloaded update programs to the in-vehicle devices.

The first communication line 3 and the second communication lines 4a and 4b are each constituted of a bus for communication in conformity with standards such as CAN and Ethernet (registered trademark), or a communication line for peer to peer (P2P) communication. The first communication line 3 may be constituted of a single communication line, constituted of a plurality of communication lines for communication in conformity with the same standard, or constituted of a plurality of communication lines for communication in conformity with different standards. The same applies to the second communication lines 4a and 4b.

The first communication line 3 is connected, via an in-vehicle connection link 5, to an infotainment control box (ICB) 6, a rear camera 7, a speaker 8, a microphone 9, an instrument panel 10 and a steering switch 11. The rear camera 7 is a camera that takes an image of the rear side of the vehicle. The instrument panel 10 displays information about the operation state of the vehicle, including vehicle speed.

The in-vehicle connection link 5 is also connected to a telematics control unit (TCU) 12, a vehicle to everything (V2X) communication device 13, a global navigation satellite system (GNSS) sensor 14 and a touch panel 15. The TCU 12 is a wireless communication device that conforms to communication standards of mobile communication systems. The V2X communication device 13 provides inter-vehicle communication and/or road-vehicle communication. The touch panel 15 includes a display 16 and a touch sensor 17.

The ICB 6 is an in-vehicle infotainment (IVI)-ECU. The ICB 6 uses the speaker 8, the microphone 9, the GNSS sensor 14, the touch panel 15, and the like, to provide occupants of the vehicle with a variety of information and entertainment.

The in-vehicle connection link 5 is constituted of a plurality of communication transmission lines conforming to various communication standards. The in-vehicle connection link 5 may include, for example, a plurality of network transmission lines. In this case, the plurality of network transmission lines may be connected with each other through, for example, devices with a gateway function. The in-vehicle connection link 5 may also include a transmission line for P2P communication. For the network transmission paths, various communication buses for network communication in conformity with various standards can be adopted. Examples of the standards of this type may include CAN, Ethernet, universal serial bus (USB), local interconnect network (LIN), and low voltage differential signaling (LVDS), though other standards may also be adopted.

The second communication line 4a is connected to a zone A-ECU 24. The zone A-ECU 24 is connected to a driving device 25, a battery 26, a maneuvering operation tool 27, and an advanced driver-assistance system (ADAS)-ECU 23. The maneuvering operation tool 27 may include a brake, an accelerator, an electric power steering (EPS), and the like. The driving device 25 is, for example, a motor or an internal combustion engine that drives the vehicle.

The second communication line 4b is connected to a zone B-ECU 29. The zone B-ECU 29 is connected to a lamp body 30 and a driver monitoring camera (DMC) 18 that monitors a driver. Examples of the lamp body 30 include headlamps, tail lamps and direction indicators. The zone B-ECU 29 is also connected to a door lock mechanism 33, an electronic steering lock (ESL) 34 and an air conditioner 35. The door lock mechanism 33 locks and unlocks vehicle doors.

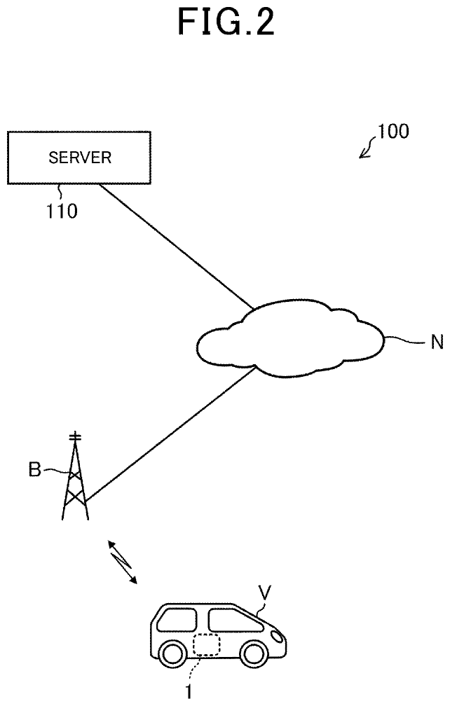

FIG. 2 shows schematic configuration of a data management system 100.

The data management system 100 is a system for a server 110 to collect data to be processed by various ECUs constituting the control system 1. The data management system 100 includes a control system 1 mounted on a vehicle V, and the server 110.

The server 110 is comprised by a computer and connected to the control system 1 through a communication network N.

The communication network N includes, for example, cellular networks, Wi-Fi (registered trademark) networks, Bluetooth (registered trademark), Internet, wide area networks (WANs), local area networks (LANs), public lines, provider devices, leased lines, base stations, and the like. FIG. 2 illustrates a base station B. The communication network N may include routers, servers, gateways, or other network equipment.

The TCU 12 included in the control system 1 performs cellular communication with the base station B so as to execute data communication with external devices through the communication network N.

There is no limit to the number of the control systems 1 communicating with the server 110. For example, the control system 1 is mounted on one vehicle V. The server 110 is capable of communicating with each of the control systems 1 mounted on a plurality of vehicles V. The server 110 may be constituted of a plurality of server devices, and the data management system 100 may include a plurality of servers 110.

The control system 1, as described above, has various ECUs mounted on the vehicle V. The control system 1 collects data from the ECUs included in the control system 1, and transmits the collected data to the server 110 through the communication network N.

The data collected by the control system 1 is data on the vehicle V, which is detected or generated in relation to the operation of the vehicle V. Specifically, the data is travel data relating to the travel of the vehicle V, examples of which may include position information on the vehicle V, and a travel locus of the vehicle V. The data collected by the control system 1 may also include information about the surrounding situation of the vehicle. Specifically, the data may include information about other vehicles present around the vehicle V, such as the number of other vehicles present around the vehicle V and the speed of the other vehicles. The data about the surrounding situation of the vehicle may include information about traffic congestion, information about road construction works or other construction works, information about traffic obstacles such as traffic accidents and road damage, weather information, and the like. The pieces of information are included, for example, in the data collected from the various ECUs mounted on the vehicle V. For example, the above information can be obtained from an image captured by a camera known as a multi view camera (MVC). Specifically, the information about traffic congestion, the information about road construction works or other construction works, the information about traffic obstacles such as traffic accidents and road damage, the weather information, and the like, can be obtained from images taken by a camera that photographs the front side of the vehicle V and by cameras that photograph the lateral sides of the vehicle V. An ECU not illustrated may acquire the above information by using a radar sensor (not illustrated) and a sonar (not illustrated) included in the vehicle V.

The server 110 corresponds to an example of the external device of the control system 1. The TCU 12 in the control system 1 corresponds to an example of the communication unit.

In the control system 1, the function of collecting data and transmitting the data to the server 110 is provided in the central ECU 2, for example.

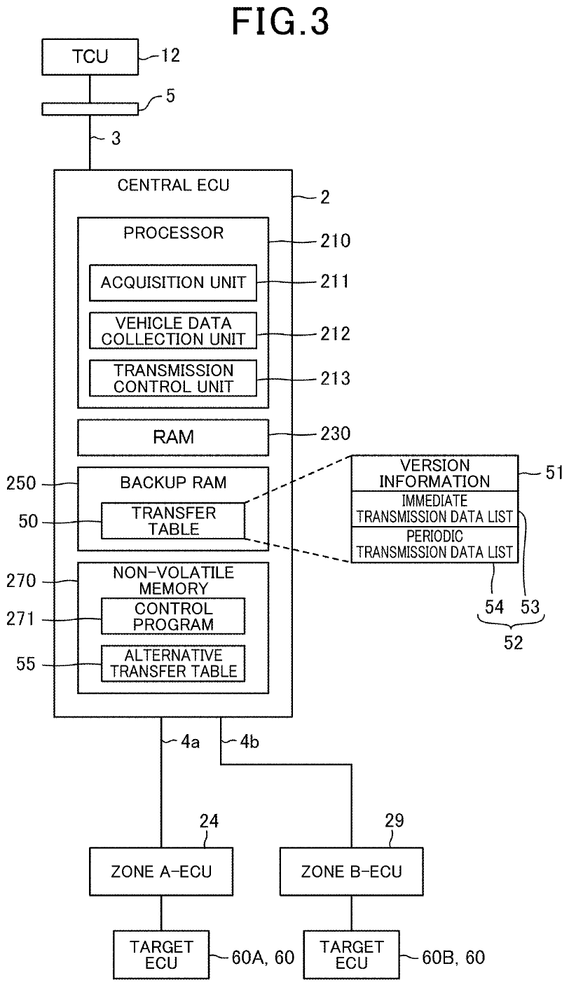

FIG. 3 is a block diagram showing the configuration of the central ECU 2.

The central ECU 2 includes a processor 210, a random access memory (RAM) 230, a backup RAM 250, and a non-volatile memory 270. The central ECU 2 may include these components as independent hardware or may be constituted as an integrated circuit that integrates some or all of these functions. The central ECU 2 corresponds to an example of the control device in the present disclosure.

The central ECU 2 includes a communication circuit and an interface circuit that executes communication through a first communication line 3, a first communication line 3b, a first communication line 3c, a second communication line 4a, and a second communication line 4b, though illustration and description thereof are omitted here.

The processor 210 is constituted of, for example, a central processing unit (CPU), a micro controller unit (MCU), and a micro processor unit (MPU). The processor 210 executes the function of controlling the control system 1 by executing a control program 271 stored in the non-volatile memory 270. The processor 210 may be constituted of a plurality of processors.

The RAM 230, which is a storage device having a volatile storage area, is constituted of semiconductor memory elements, for example. The RAM 230 forms work areas for temporarily storing the programs executed by the processor 210 and data processed by the processor 210.

The backup RAM 250, which is a storage device having a volatile storage area, is constituted of a semiconductor memory elements, for example. The backup RAM 250, which has a storage area not used for formation of work areas, stores a transfer table 50 in this storage area.

The RAM 230 and the backup RAM 250 are each constituted of, for example, a dynamic RAM (DRAM) or a synchronous DRAM (SDRAM). The RAM 230 and the backup RAM 250 may be provided by dividing the storage area of the same semiconductor memory elements, or they may be constituted of different hardware.

The RAM 230 requires a memory cell refresh operation to maintain the state of the data stored in the RAM 230. The backup RAM 250 similarly requires a memory cell refresh operation to maintain the state of the data stored in the backup RAM 250. Therefore, the RAM 230 and the backup RAM 250 require power supply to maintain data, and when the power supply to the RAM 230 or the backup RAM 250 is interrupted, data may be lost.

The non-volatile memory 270 is a storage device having a non-volatile storage area. The non-volatile memory 270 may be a rewritable storage device, such as a flash read only memory (ROM), an electrically erasable programmable ROM (EEPROM), or a magnetic storage device. The non-volatile memory 270 may be a non-rewritable storage device.

The non-volatile memory 270 stores programs executed by the processor 210 and data processed by the processor 210. For example, the non-volatile memory 270 stores the control program 271, and an alternative transfer table 55. The non-volatile memory 270 may have a storage area where rewriting is limited, and the alternative transfer table 55 may be stored in this storage area.

The transfer table 50 includes version information 51 and a data list 52. The version information 51 indicates the version of the transfer table 50. As described later, the processor 210 can update the transfer table 50 stored in the backup RAM 250 by downloading the transfer table 50 from the server 110. The version information 51 can be used as information that discriminates which is new or old, the transfer table 50 before update and the transfer table 50 downloaded from the server 110. The transfer table 50 corresponds to an example of the designation data in the present disclosure. The backup RAM 250 corresponds to an example of the designation data storage unit in the present disclosure.

The data list 52 designates the data to be collected by the central ECU 2 in the control system 1. The data list 52 includes a data item to be collected by the central ECU 2, and when a plurality of data items are included, the data list 52 has a list format. The data list 52 may include information identifying the ECUs, which can acquire the data, in association with the data items.

In the following description, out of the various ECUs included in the control system 1, the ECUs subjected to data collection by the central ECU 2 are referred to as target ECUs 60. Each target ECUs 60 has a processor. FIG. 3 shows a target ECU 60A connected to the zone A-ECU 24, and a target ECU 60B connected to the zone B-ECU 29. When the target ECU 60A and the target ECU 60B are not distinguished, they are each described as the target ECU 60. The target ECU 60A in FIG. 3 is not necessarily a single ECU. The target ECU 60A may be a representative of a plurality of ECUs. The same applies to the target ECU 60B. The target ECU 60 corresponds to an example of the vehicle control unit in the present disclosure.

The target ECU 60A includes ECUs that control the driving device 25, the battery 26, the maneuvering operation tool 27, a VSA device 28, and the like. The target ECU 60B includes various ECUs connected to the zone B-ECU 29. For example, the various ECUs include the ECUs that control the DMC 18, the lamp body 30, the door lock mechanism 33, the ESL 34, the air conditioner 35, and the like. Examples of the target ECU 60 may include the ECUs relating to the ICB 6, the rear camera 7, the speaker 8, the microphone 9, the instrument panel 10, the steering switch 11, the TCU 12, the V2X communication device 13, the GNSS sensor 14 and the touch panel 15. The target ECU 60 may also include ECUs not shown in FIG. 1.

The central ECU 2 acquires data from the target ECU 60A by executing communication with the target ECU 60A via the zone A-ECU 24. The central ECU 2 acquires data from the target ECU 60B by executing communication with the target ECU 60B via the zone B-ECU 29. The operation of the central ECU 2 acquiring data from the target ECU 60 is called collection, and a series of processing performed by the central ECU 2 to collect data is called collection processing.

The data list 52 includes an immediate transmission data list 53 and a periodic transmission data list 54. The immediate transmission data list 53 includes data items that are required to be transmitted immediately to the server 110. When acquiring the data designated by the immediate transmission data list 53 from the target ECU 60, the central ECU 2 promptly transmits the acquired data to the server 110.

The periodic transmission data list 54 includes data items that are required to be collected from the target ECU 60 and then be transmitted to the server 110 at predetermined timing. When acquiring the data designated by the periodic transmission data list 54 from the target ECU 60, the central ECU 2 accumulates the data acquired from the target ECU 60 in the RAM 230 until predetermined timing comes. The central ECU 2 transmits the data accumulated in the RAM 230 to the server 110 at predetermined timing. The predetermined timing for the central ECU 2 to transmit the data to the server 110 is, for example, every predetermined period or at specified date and time. For example, the information designating the predetermined timing is transmitted from the server 110 to the central ECU 2, or is included in the transfer table 50.

The data designated by the immediate transmission data list 53 or the periodic transmission data list 54 are data relating to the vehicle V, which corresponds to an example of the vehicle data in the present disclosure.

The processor 210 includes an acquisition unit 211, a vehicle data collection unit 212, and a transmission control unit 213. These are functional units formed in collaboration between hardware and software when the processor 210 executes the control program 271.

The acquisition unit 211 executes communication with the server 110 using the TCU 12 to acquire the transfer table 50 from the server 110. The acquisition unit 211 stores the transfer table 50, acquired from the server 110, in the backup RAM 250. When the transfer table 50 is stored in the backup RAM 250, the acquisition unit 211 replaces the transfer table 50 stored in the backup RAM 250 with the transfer table 50 received from the server 110 for update. The acquisition unit 211 corresponds to an example of the designation data acquisition unit in the present disclosure.

The vehicle data collection unit 212 collects data from one or more target ECUs 60 included in the control system 1 in accordance with the transfer table 50.

The transmission control unit 213 transmits the data collected by the vehicle data collection unit 212 to the server 110.

As described above, the backup RAM 250 requires power supply to maintain data. Accordingly, when power supply to the backup RAM 250 is interrupted, the transfer table 50 may be lost.

In the control system 1, the central ECU 2 is constantly supplied with power from the battery 26 or other power sources. Even when the vehicle V is stopped or parked, power supply to the central ECU 2 continues. However, power supply to the central ECU 2 can be interrupted, when the central ECU 2 is disconnected from the power source or when the battery 26 is removed from the vehicle V. To prepare for such cases, the central ECU 2 stores the alternative transfer table 55 in the non-volatile memory 270.

As in the case of the data list 52 included in the transfer table 50, the alternative transfer table 55 designates vehicle data to be collected by the central ECU 2 in the control system 1. The alternative transfer table 55 includes a data item to be collected by the central ECU 2, and when including a plurality of data items, the alternative transfer table 55 has a list format. The alternative transfer table 55 corresponds to an example of the alternative designation data in the present disclosure. The non-volatile memory 270 corresponds to an example of the alternative data storage unit in the present disclosure.

The alternative transfer table 55 may include information identifying the ECUs, which can acquire the data, in association with the data items. The alternative transfer table 55 may also include information indicating that it is the alternative table different from the transfer table 50, in the format of the version information 51, for example.

When the acquisition unit 211 is unable to refer to the transfer table 50 stored in the backup RAM 250, the acquisition unit 211 reads the alternative transfer table 55 from the non-volatile memory 270, and expands the alternative transfer table 55 in the RAM 230 for reference. This allows the vehicle data collection unit 212 to collect data by reading the alternative transfer table 55 as alternative information of the transfer table 50, even when the memory of the transfer table 50 is lost.

The alternative transfer table 55 does not have to be exactly the same as the transfer table 50. The data items designated by the alternative transfer table 55 may be less than those of the transfer table 50. For example, the alternative transfer table 55 may designate only the minimum data to be collected in the control system 1. The minimum data is data that is considered essential even when the purpose of use of the data is changed. Specifically, the minimum data is the data that is designated at the time of shipment of the vehicle V from the factory and that is designated by the oldest version of the transfer table 50.

The alternative transfer table 55 may also be information that designates only the data items included in the immediate transmission data list 53. The alternative transfer table 55, like the transfer table 50, may include the immediate transmission data list 53 and the periodic transmission data list 54. In this case, the immediate transmission data list 53 and the periodic transmission data list 54 included in the alternative transfer table 55 may be data that designate less data items than the immediate transmission data list 53 and the periodic transmission data list 54 included in the transfer table 50.

Description is given of specific examples of the data collected in the control system 1. The data collected in control system 1 include, for example, data relating to the operation of the vehicle V. Specifically, the data is position information and/or time information in the event of a sudden braking operation or acceleration operation in the vehicle V. The data is also position information and/or time information at the occurrence of events, such as an airbag being expanded in the vehicle V, collision of the vehicle V, and acceleration above a threshold being applied to the vehicle body of the vehicle V.

The data collected in the control system 1 includes, for example, data relating to maintenance of the vehicle V. Specifically, the data is a total travel distance of the vehicle V, a replacement history of fluids, or a replenishment history of fluids. Here, fluids may be engine oil, radiator cooling fluids, screen washer fluids, and the like.

When the vehicle V is an electric vehicle or a hybrid vehicle including a motor as the driving device 25, the data relating to the maintenance of the vehicle V include one or more of a remaining electric power of the battery 26 that is a driving battery for driving the motor, and a total capacity of the battery 26. When the vehicle V is a vehicle having an internal combustion engine as the driving device 25, the data relating to the maintenance of the vehicle V may include the remaining amount of fuel. When the battery 26 is a starting battery that starts the internal combustion engine and/or each unit of the control system 1, the data relating to the maintenance of the vehicle V may include the voltage of the battery 26.

The data collected in the control system 1 may include data indicating user operation, or the like, of the vehicle V. Here, the user includes not only the driver but also passengers. The data of this type is, for example, music and moving images reproduced by the ICB 6 of the vehicle V, entertainment applications executed by the ICB 6, or the like.

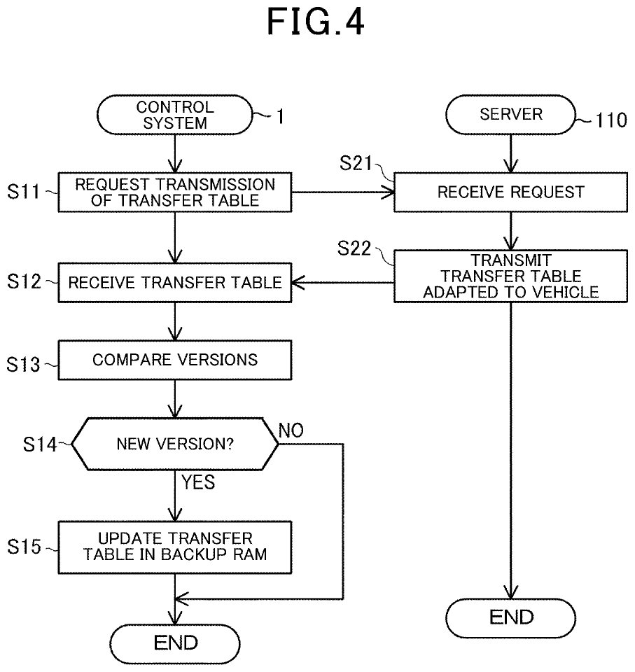

FIG. 4 is a flowchart showing the operation of the control system 1, in which the control system 1 acquires the transfer table 50 from the server 110. FIG. 4 shows each of the operation of the control system 1 and the operation of the server 110. The acquisition unit 211 of the central ECU 2 executes steps S11 to S15. The server 110 executes the operation of steps S21 to S22.

In the control system 1, the central ECU 2 controls the TCU 12 to request the server 110 to transmit the transfer table 50 (step S11). The request transmitted in step S11 may include identification information that identifies the vehicle V, and information indicating a vehicle model, specification, equipment of the vehicle V. For example, the request transmitted in step S11 may include a vehicle identification number (VIN) of the vehicle V.

The server 110 receives the request from the control system 1 (step S21), and transmits the transfer table 50 adapted to the vehicle V to the control system 1 (step S22). For example, based on the identification information or the like included in the request received in step S21, the server 110 selects, out of the transfer tables 50 held in the server 110, the transfer table 50 adapted to the vehicle V, and transmits the selected transfer table 50.

The control system 1 receives the transfer table 50 from the server 110 (step S12). In step S12, the control system 1 may temporarily store the received transfer table 50 in the RAM 230. The control system 1 compares the version of the received transfer table 50 with the transfer table 50 stored in the backup RAM 250 (step S13). In step S13, for example, the version information 51 included in both the transfer tables 50 are compared with each other.

The control system 1 determines whether or not the version of the transfer table 50 received in step S12 is newer than the version of the transfer table 50 stored in the backup RAM 250 (step S14). When the transfer table 50 received in step S12 is a newer version (YES in step S14), the control system 1 shifts to step S15. In step S15, the control system 1 overwrites the transfer table 50 stored in the backup RAM 250 with the transfer table 50 received in step S12 for update (step S15), and ends the processing. When the transfer table 50 received in step S12 is not a newer version (NO in step S14), the control system 1 ends the processing. After the processing of FIG. 4, the control system 1 may erase the transfer table 50 stored in the RAM 230.

In addition to updating the transfer table 50 through the operation described in FIG. 4, the control system 1 can request a new transfer table 50 from the server 110, and update the transfer table 50 in accordance with the surrounding situation or in-vehicle situation of the vehicle V or the like which is mounted with the control system 1. Specifically, when a specific situation occurs around the vehicle V, the central ECU 2 detects the specific event. The specific event is a preset situation with respect to the surrounding situation of the vehicle. Examples of the specific event may include that the situations of other vehicles present around the vehicle V, such as the number of other vehicles present around the vehicle V, and the speed of other vehicles, satisfy specific conditions. Examples of the specific event may also include that traffic congestion, road construction works or other construction works, traffic obstacles such as traffic accidents and road damage, weather, and the like, as the situation around the vehicle V, satisfy preset specific conditions. The specific event may be the situation inside the vehicle. For example, in the configuration where the central ECU 2 acquires the information from a sensor mounted on a portable device that can communicate with the control system 1, the specific event may be detected based on the information acquired by the central ECU 2. In this case, the information acquired by the central ECU 2 may include heart rate, blood oxygen concentration, blood pressure, and body temperature of the passengers and the driver of the vehicle V. The central ECU 2 can detect the specific event, such as sickness of the passengers and the driver, by acquiring detection values of pulse sensors, blood oxygen sensors, pressure sensors, temperature sensors, and the like, and analyzing the acquired information.

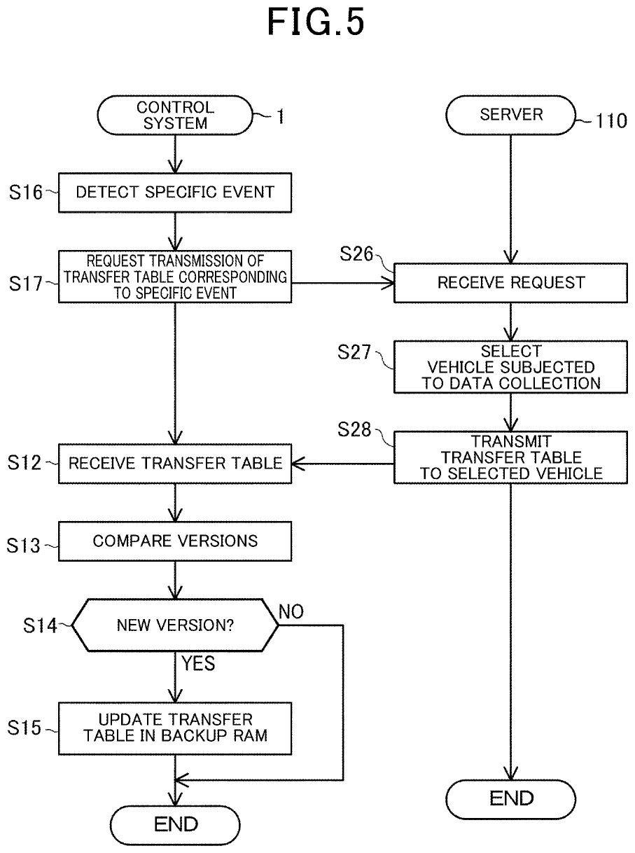

FIG. 5 is a flowchart showing the operation of the control system 1, in which the control system 1 acquires the transfer table 50 from the server 110. FIG. 5 shows each of the operation of the control system 1 and the operation of the server 110. The acquisition unit 211 of the central ECU 2 executes steps S12 to S17. The server 110 executes the operation of steps S26 to S28.

FIG. 5 shows the operation of the control system 1 acquiring the transfer table 50 for the server 110 to collect data about a specific event from the vehicle V, when the specific event occurs around the control system 1.

In FIG. 5, steps S12 to S15 are processing executed as in FIG. 4, and thus the description thereof is omitted here.

The control system 1 detects occurrence of a specific event (step S16). In step S16, the control system 1 detects the specific event based on, for example, an image captured by the camera of the MVC described above, a detection result of a radar sensor, a sonar, or the like, which is not illustrated, or information that the control system 1 acquires from other devices through communication. The control system 1 requests the server 110 to transmit the transfer table 50 corresponding to the specific event detected in step S16 (step S17). The request in step S17 may include, as in step S11, identification information that identifies the vehicle V and information indicating a vehicle model, specification, equipment, or the like, of the vehicle V. The request in step S17 may also include information that designates, for example, the type of the specific event detected by the control system 1 in step S16.

The server 110 receives the request from the control system 1 (step S26), and selects the vehicle V subjected to data collection regarding the specific event (step S27).

When the plurality of vehicles V performs the operation of FIG. 5, one specific event may be detected by the plurality of vehicles V. Such tendency is seen in large-scale specific events or specific events involving a large number of vehicles, such as traffic congestion. When a large number of vehicles V detect a specific event, the server 110 can collect sufficient data by some of the vehicles V transmitting the data to the server 110. For this reason, the server 110 has a function of selecting, out of the vehicles V that have detected a specific event, some vehicles V subjected to collection of data regarding the specific event based on the transfer table 50.

In step S27, the server 110 selects some vehicles V based on, for example, the number of vehicles V that have requested the transfer table 50 corresponding to the specific event, and the position of each vehicle V, or the like. For example, in the case of a specific event detected in images captured by the cameras mounted on the vehicles V, the server 110 may select the vehicles V entering the area where the specific event is detected. In step S27, the server 110 may determine the number of vehicles V to be selected, in accordance with the number of vehicles V positioned within a specific area including the location where the specific event is detected. The server 110 may also determine the priority when the vehicles V transmit data based on the transfer table 50 in step S27. The priority is the priority of the server 110 receiving data from the control systems 1. For example, the server 110 may determine the priority of the control systems 1 based on the position of the vehicles V. The server 110 may also determine the number of vehicles V to be selected in step S27, based on the type and content of the specific event.

The server 110 selects the vehicles V in step S27 so that the communication traffic from the control systems 1 to the server 110 can effectively be reduced, and efficient data collection can be achieved.

The server 110 transmits, in response to the request, the transfer table 50 to the vehicle V selected in step S27 (step S28). The control system 1 performs the same operation as in step S12 and subsequent steps in FIG. 4, and performs operation based on the new transfer table 50.

According to the operation shown in FIG. 5, the control system 1 can detect or acquire the situations inside and outside the vehicle V, and can acquire the transfer table 50 corresponding to the situations from the server 110. The transfer table 50 is data that designates transmission of the data relating to the specific event to the server 110. The transfer table 50 may be data that can dynamically change the number of data items that the control system 1 transmits to the server 110 or frequency of the transmission. For example, the transfer table 50 corresponding to a specific weather condition may include changing the type of data that the control system 1 transmits to the server 110, changing the period of data transmission, and changing the period of data acquisition.

In the present embodiment, the backup RAM 250 is used as an area for the central ECU 2 to store the transfer table 50. The central ECU 2 has the non-volatile memory 270 as a storage area. The non-volatile memory 270 is typically provided as an area for the ECUs mounted on the vehicle V to store the control program 271 and the like. Since rewriting programs and data stored in the non-volatile memory 270 may affect the function of the vehicle V, the rewriting is executed based on a procedure predetermined to ensure reliability. The procedure is, for example, the OTA described above. There is also a procedure to update the programs and data stored in the non-volatile memory 270 by, for example, connecting a vehicle diagnostic apparatus, which is not illustrated, installed at dealerships or workshops handling the vehicle V to the control system 1. Such restrictions are achieved as a procedure for the processor 210 to permit access that involves rewriting of the non-volatile memory 270. Therefore, a removal of restrictions regarding rewriting of the non-volatile memory 270 is hardly assumed.

When the transfer table 50 is stored in the non-volatile memory 270, it becomes necessary to use the OTA, the dealership or the workshop of the vehicle V to change the content of the transfer table 50. Therefore, it is not easy to change the content of the transfer table 50.

The control system 1, on the other hand, stores the transfer table 50 in the backup RAM 250. Changing the data stored in the backup RAM 250 is less restrictive than rewriting the non-volatile memory 270. Accordingly, the transfer table 50 can be updated by the operation described in FIG. 4, for example. Therefore, it is possible to change the data item designated by the transfer table 50, in accordance with the purpose of utilization or the use status of the data that the data management system 100 collects from the vehicle V.

In the configuration of using semiconductor memory elements for a non-volatile storage unit, such as the non-volatile memory 270, the number of times of rewriting affects the lifetime of the elements. In the configuration where the backup RAM 250 stores the transfer table 50, updating the transfer table 50 does not increase the number of times of rewriting the non-volatile memory 270, and thus the transfer table 50 can be updated without affecting the lifetime of the non-volatile memory 270.

The transfer table 50 is also stored in the backup RAM 250, which is different from the RAM 230. As a consequence, even when data or programs stored in the RAM 230 are rewritten along with the operation of the processor 210, the transfer table 50 is not affected. Therefore, it is possible to avoid the risk of losing or damaging the transfer table 50.

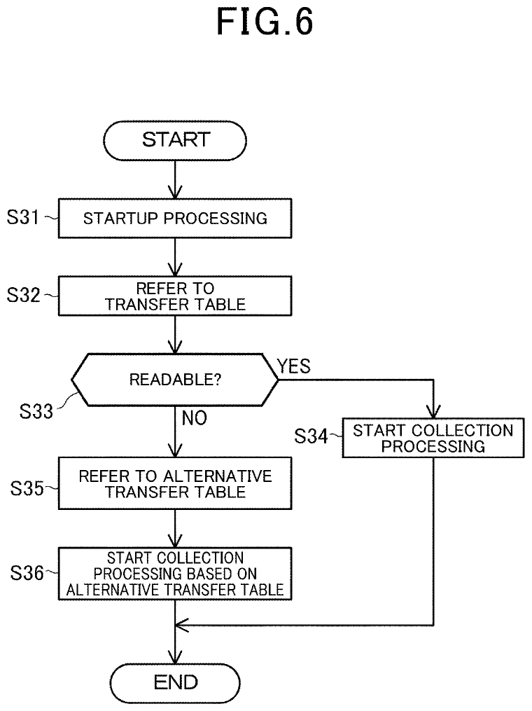

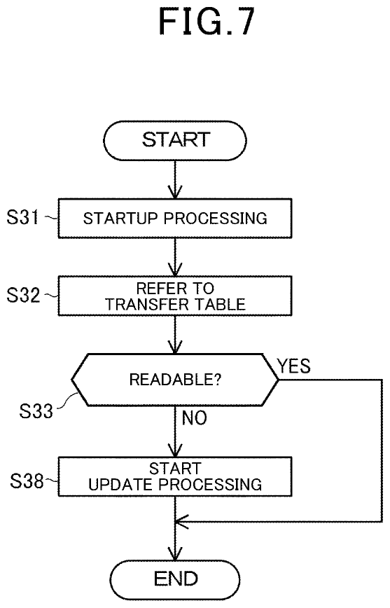

Even when the transfer table 50 stored in the backup RAM 250 is lost for some reason, the control system 1 is configured to recover from such a situation. Specifically, the control system 1 is configured to use the alternative transfer table 55 stored in the non-volatile memory 270, or configured to acquire a new transfer table 50 by the function of the control program 271. Description thereof will be given with reference to FIGS. 6 and 7.

FIGS. 6 to 9 are flowcharts showing the operation of the central ECU 2.

FIG. 6 shows an example of operation in the case where power supply to the central ECU 2 is interrupted, and then with restart of power supply, the central ECU 2 is started up.

The processor 210 executes startup processing with the start of power supply (step S31). The startup processing of step S31 includes reading the control program 271, initializing each unit of the central ECU 2, and initializing communication with each unit connected to the central ECU 2.

The processor 210 accesses the backup RAM 250 with the function of the acquisition unit 211, and tries to refer to the transfer table 50 (step S32). The processor 210 determines whether or not the transfer table 50 is readable with the acquisition unit 211 (step S33).

Here, when determination is made that the transfer table 50 is readable (YES in step S33), the vehicle data collection unit 212 starts collection processing based on the transfer table 50 (step S34). The collection processing will be described later in detail.

When determination is made that the transfer table 50 is not readable (NO in step S33), the vehicle data collection unit 212 refers to the alternative transfer table 55 stored in the non-volatile memory 270 (step S35). The vehicle data collection unit 212 starts the collection processing based on the alternative transfer table 55 (step S36).

In step S35, the processor 210 reads the alternative transfer table 55 from the non-volatile memory 270, and expands it in the RAM 230 for reference. The processor 210 may store the alternative transfer table 55 in the backup RAM 250.

FIG. 7 shows another example of operation in the case where power supply to the central ECU 2 is interrupted, and then with restart of power supply, the central ECU 2 is started up. The operations in FIG. 7 in common with those in FIG. 6 are designated by the same step numbers, and description thereof is omitted.

The processor 210 determines whether or not the transfer table 50 is readable (step S33), and when it is determined that the transfer table 50 is readable (YES in step S33), the processor 210 ends the processing. In this case, the processor 210 may execute the collection processing at another timing. For example, the processor 210 executes the collection processing every predetermined period or every time the vehicle V is put in a particular state.

When determination is made that the transfer table 50 is not readable (NO in step S33), the acquisition unit 211 starts update processing of downloading the transfer table 50 from the server 110 (step S38). Specifically, the update processing is the operation shown in FIG. 4.

The operation shown in FIG. 7 can be achieved by the processor 210 executing the control program 271. Hence, even when the transfer table 50 stored in the backup RAM 250 is lost, the central ECU 2 can start up without any trouble and obtain the transfer table 50 from the server 110. Therefore, when the central ECU 2 starts up from the state such as power shutdown, and the TCU 12 can communicate with the server 110, the transfer table 50 can be recovered by executing the operation shown in FIG. 7.

The processor 210 may be able to execute one of the operation shown in FIG. 6 and the operation shown in FIG. 7. The processor 210 may also be able to selectively execute the operation shown in FIG. 6 and the operation shown in FIG. 7. For example, before or after the determination in step S33, the processor 210 may determine whether or not the TCU 12 is in the state of being able to communicate with the server 110. In this case, the processor 210 executes the operation shown in FIG. 7 when the TCU 12 is in the state of being able to communicate with the server 110, whereas the processor 210 executes the operation shown in FIG. 6 when the TCU 12 is not in the state of being able to communicate with the server 110.

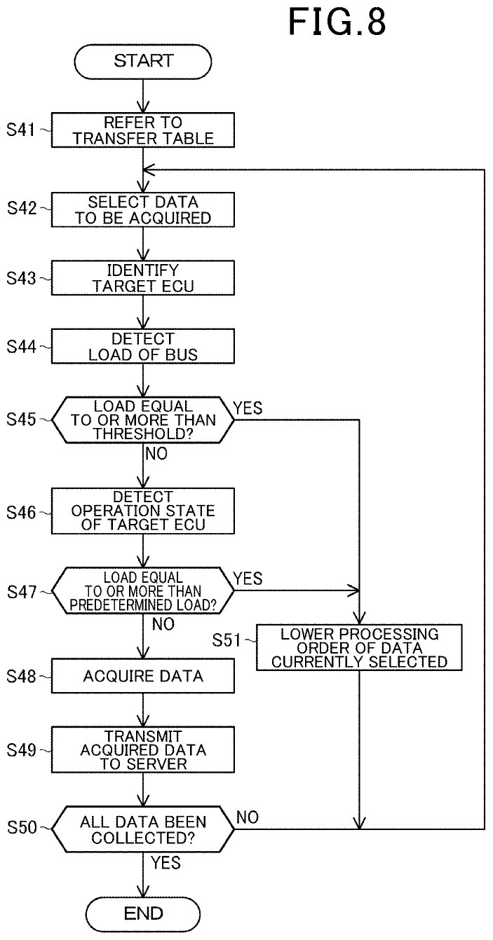

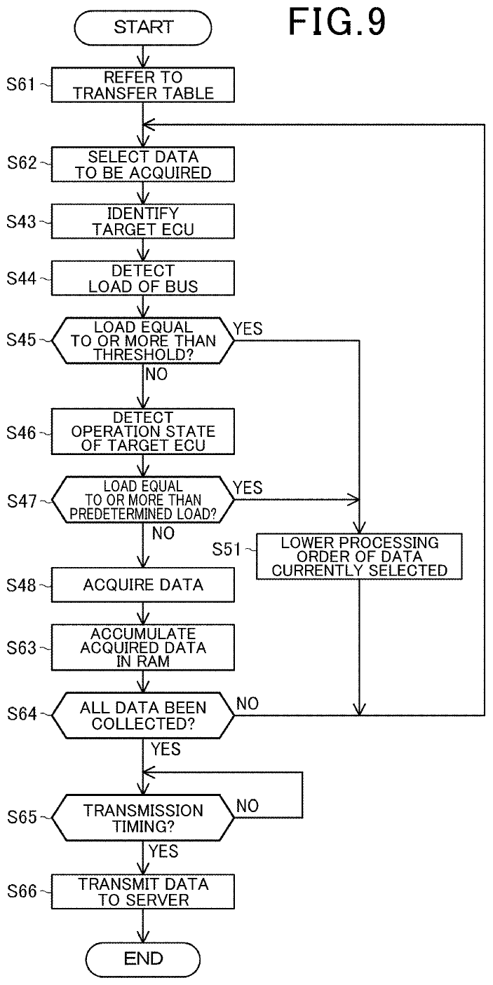

FIGS. 8 and 9 are flowcharts showing the collection processing executed by the central ECU 2. FIG. 8 shows the collection processing executed based on the immediate transmission data list 53, and FIG. 9 shows the collection processing based on the periodic transmission data list 54.

The vehicle data collection unit 212 executes steps S41 to S48 and S50 to S51 in FIG. 8, and the transmission control unit 213 executes step S49.

The vehicle data collection unit 212 refers to the transfer table 50 (step S41), and selects the data to be acquired in the control system 1, out of the data designated by the immediate transmission data list 53 (step S42). In step S42, one data item is selected, for example.

The vehicle data collection unit 212 identifies the target ECU 60 which can output the data selected in step S42 (step S43). The vehicle data collection unit 212 detects load of the bus which is connected to the identified target ECU 60 (step S44). The bus refers to the first communication line 3, the second communication lines 4a, 4b, or any other communication line of the control system 1.

When the target ECU 60 identified in step S43 is connected to the first communication line 3, the vehicle data collection unit 212 detects communication load in the first communication line 3 in step S44. The communication load is so-called traffic, which includes the frequency of communication and the amount of data transmitted per unit time.

The vehicle data collection unit 212 may allow the zone A-ECU 24 or the zone B-ECU 29 to perform detection. For example, when the load of the bus is detected for the target ECU 60 connected to the zone A-ECU 24, then the zone A-ECU 24 is made to detect traffic of the communication line which connects between the zone A-ECU 24 and the target ECU 60.

The vehicle data collection unit 212 determines whether or not the load of the bus is equal to or more than a predetermined threshold (step S45). When determination is made that the load is equal to or more than the threshold (YES in step S45), the vehicle data collection unit 212 shifts to step S51 described later.

When determination is made that the load of the bus is less than the threshold (NO in step S45), the vehicle data collection unit 212 detects the operation state of the target ECU 60 (step S46). In step S46, the vehicle data collection unit 212 may allow the zone A-ECU 24 or the zone B-ECU 29 to perform detection. For example, the zone A-ECU 24 may be made to detect the state of the target ECU 60 connected to the zone A-ECU 24.

The vehicle data collection unit 212 determines, based on the detection result in step S46, whether or not the load of the target ECU 60 is equal to or more than a predetermined load (step S47). For example, when the target ECU 60 is continuously in a busy state for a predetermined time or more, the vehicle data collection unit 212 determines that the load of the target ECU 60 is equal to or more than the predetermined load (YES in step S47). In this case, the vehicle data collection unit 212 shifts to step S51.

When determination is made that the load of the target ECU 60 is less than the predetermined load (NO in step S47), the vehicle data collection unit 212 acquires data from the target ECU 60 (step S48). The transmission control unit 213 transmits the data acquired by the vehicle data collection unit 212 to the server 110 with the TCU 12.

The vehicle data collection unit 212 then determines whether or not all the data designated by the immediate transmission data list 53 have been collected (step S50). When all the data have been collected (YES in step S50), the vehicle data collection unit 212 ends the processing.

When there is any data not yet collected (NO in step S50), the vehicle data collection unit 212 returns to step S42 to select another data.

In step S51, the vehicle data collection unit 212 also performs processing to lower the order of processing the data selected in step S42 (step S51). Specifically, out of the data designated by the immediate transmission data list 53, the data selected in step S42 is set to be acquired after the other data. As a result, when the processing load of the target ECU 60 is equal to or more than the predetermined load, and when the load of the bus connected to the target ECU 60 is equal to or more than the threshold, the vehicle data collection unit 212 does not acquire data from the pertinent target ECU 60. Therefore, it is possible to acquire the data relating to the vehicle V without disturbing control of the vehicle V and without interfering with the entertainment function of the IVI.

After step S51, the vehicle data collection unit 212 returns to step S42.

The operations in FIG. 9 in common with those in FIG. 8 are designated by the same step numbers, and description thereof is omitted.

The vehicle data collection unit 212 executes steps S43 to S48, S51, and S61 to S64 in FIG. 9, and the transmission control unit 213 executes steps S65 to S66.

The vehicle data collection unit 212 refers to the transfer table 50 (step S61), and selects the data to be acquired in the control system 1, out of the data designated by the periodic transmission data list 54 (step S62). In step S62, one data item is selected, for example.

The vehicle data collection unit 212 then executes processing of steps S43 to S47, and when determination is made that the load of the target ECU 60 is not equal to the predetermined load or more (NO in step S47), the vehicle data collection unit 212 acquires data from the target ECU 60 (step S48).

The vehicle data collection unit 212 accumulates the data acquired in step S48 in the RAM 230 (step S63). The vehicle data collection unit 212 determines whether or not all the data designated by the periodic transmission data list 54 have been collected (step S64).

When there is any data not yet collected (NO in step S64), the vehicle data collection unit 212 returns to step S62 to select another data. After processing in step S51, the vehicle data collection unit 212 returns to step S62.

Meanwhile, when determination is made that all the data have been collected (YES in step S64), the transmission control unit 213 determines whether or not transmission timing has come (step S65), and while transmission timing does not yet come (NO in step S65), the transmission control unit 213 waits in step S65. When the transmission timing has come (YES in step S65), the transmission control unit 213 transmits the data accumulated in the RAM 230 to the server 110 with the TCU 12 (step S66).

As described in FIGS. 8 and 9, the vehicle data collection unit 212 and the transmission control unit 213 collect the data designated by the transfer table 50, and transmit the data to the server 110. The technology of the present disclosure is not limited to this operation. For example, the vehicle data collection unit 212 may detect that the data designated by the transfer table 50 is output from the target ECU 60, and acquire the data. For example, the vehicle data collection unit 212 acquires the data, when any one of the ECUs in the control system 1 outputs data indicating, for example, sudden brake operation, sudden accelerator operation, airbag expansion, collision of the vehicle V, and acceleration above a threshold being applied to the vehicle body of the vehicle V. The data acquired by the vehicle data collection unit 212 are, for example, data indicating the type of an event that occurs, and position information and/or time information when the event occurs. In this case, the transmission control unit 213 immediately transmits the data acquired by the vehicle data collection unit 212 to the server 110 with the TCU 12, in the same way as the data designated by the immediate transmission data list 53.

The above embodiment shows a specific example in which the present invention is applied, and does not limit the form of application of the present invention.

In the above embodiment, the configuration where the transfer table 50 is stored in the backup RAM 250 has been described. The present invention is not limited to the configuration, and the area for storing the transfer table 50 may be any storage area that is not usually rewritten by the function of the processor 210. For example, the central ECU 2 may be configured to store the transfer table 50 in a non-volatile storage. In this case, the transfer table 50 is preferably stored in a storage area that is different from the area for storing the control program 271, or the like, which can be a target of rewriting.

In the above embodiment, examples in which the central ECU 2 executes the operation shown in FIGS. 4 to 9 have been described. However, the present invention is not limited to the examples. For example, separately from the central ECU 2, an ECU having the configuration shown in FIG. 3 to execute the operation shown in FIGS. 4 to 9 may be provided separately from each unit shown in FIG. 1. These configurations may also be applied to the TCU 12.

The configuration of the control system 1 shown in the above embodiment is also merely exemplary, and the type of the ECUs included in the control system 1, the number of the ECUs, and the configuration of the devices to be controlled by the ECUs can be changed in various ways.

FIGS. 1 and 3 are schematic configuration diagrams showing the functional configuration of respective devices of the data management system 100, the functional configuration being divided according to main processing contents for easy understanding of the present invention, and therefore, FIGS. 1 and 3 are not intended to limit the configuration of the devices. Each processing shown in FIGS. 4 to 9 may be executed by a single program or may be executed by a plurality of programs.

Although the vehicle V is, for example, a four-wheeled vehicle, the type of vehicle V is not particularly restricted, and the vehicle V may be a large-sized automobile, a commercial vehicle, a two-wheeled vehicle, a three-wheeled vehicle, and the like. In addition, the configuration of each unit in the control system 1 can be changed in any way.

The details described in the present embodiment may properly be combined. For example, all the configurations 1 to 11 described below can be combined with any other configurations.

The above embodiment supports the following configurations.

### (Configuration 1)

A control device mounted on a vehicle, including: a designation data acquisition unit that acquires designation data from an external device of the vehicle, the designation data designating vehicle data that is subjected to collection processing; a designation data storage unit that stores the designation data; a vehicle data collection unit that executes the collection processing to collect the vehicle data designated by the designation data, from the vehicle; and a transmission control unit that transmits the vehicle data collected by the vehicle data collection unit, to the external device through a communication device.

The control device in the configuration 1 allows the external device to designate the content and type of vehicle data collected by the control device. This makes it possible to easily change the type and the number of vehicle data collected from the vehicle. Accordingly, efficient collection of necessary vehicle data can be achieved in response to social situations or demands of data. This makes it possible to promote utilization of data relating to the vehicle and achieve, for example, improvement of energy efficiency.

### (Configuration 2)

The control device according to configuration 1, in which when the designation data is acquired from the external device, the designation data acquisition unit updates the designation data stored in the designation data storage unit, based on the acquired designation data.

According to the control device in configuration 2, vehicle data can be collected based on the latest information by acquiring the designation data from the external device for update.

### (Configuration 3)

The control device according to configuration 2, in which when the designation data is acquired from the external device, the designation data acquisition unit compares the acquired designation data and the designation data stored in the designation data storage unit, and updates the designation data stored in the designation data storage unit, when the designation data acquired from the external device is newer.

According to the control device in configuration 3, efficiently management of the designation data can be achieved by preventing unnecessary updates, and the designation data can be kept in a latest state.

### (Configuration 4)

The control device according to configuration 1 or 2, in which when the vehicle detects a specific event, the designation data acquisition unit requests the external device to acquire the designation data corresponding to the specific event.

The control device in configuration 4 allows the vehicle to request designation data when a specific event is detected. Accordingly, the designation data can be acquired based on the reasons not limited to the state of the vehicle, and therefore the vehicle can efficiently collect data relating to other vehicles or the surrounding situation of the vehicle, for example.

### (Configuration 5)

The control device according to any one of configurations 1 to 4, in which the designation data acquisition unit requests the external device to acquire the designation data, when trouble occurs in reading the designation data stored in the designation data storage unit.

According to the control device in configuration 5, the designation data can be recovered appropriately, even when trouble occurs in the designated data stored in the designated data storage unit.

### (Configuration 6)

The control device according to any one of configurations 1 to 5, including an alternative data storage unit that stores alternative designation data, the alternative designation data designating the vehicle data that is subjected to the collection processing, in which when trouble occurs in reading the designation data stored in the designation data storage unit, the designation data acquisition unit collects the vehicle data designated by the alternative designation data.

According to the control device in configuration 6, the designation data can be acquired, even when trouble occurs in the designated data stored in the designated data storage unit.

### (Configuration 7)

The control device according to configuration 6, in which the designation data storage unit is a volatile storage unit that requires power supply for maintaining memory, and the alternative data storage unit is a non-volatile storage unit.

According to the control device in configuration 7, the designation data is stored in the volatile storage unit, so that the designation data can easily be changed. In the case where trouble occurs in reading the designation data due to power shutdown or the like, the alternative designated data stored in the non-volatile memory can be used to collect the vehicle data. In addition, since the designation data can be updated without rewriting the non-volatile storage unit, the number of times of rewriting in the non-volatile storage unit included in the control device can be reduced.

### (Configuration 8)

The control device according to any one of configurations 1 to 7, in which in the collection processing, the vehicle data collection unit acquires the vehicle data from a vehicle control unit that controls a functional unit mounted on the vehicle, and when processing load of the vehicle control unit is equal to or more than a predetermined load, the vehicle data collection unit does not acquire the vehicle data from the vehicle control unit.

According to the control device in configuration 8, the processing of collecting the vehicle data does not impose excessive load on the vehicle control unit, so that the function or operation of the vehicle control unit is not disturbed.

### (Configuration 9)

The control device according to any one of configurations 1 to 8, in which in the collection processing, when the vehicle data collection unit acquires the vehicle data from a plurality of vehicle control units, out of the vehicle control units that each control a functional unit mounted on the vehicle, the vehicle data collection unit detects processing load of the plurality of vehicle control units, and acquires the vehicle data preferentially from the vehicle control unit with smaller processing load.

According to the control device in configuration 9, vehicle data can be collected, without interfering with the function or operation of the vehicle control unit.

### (Configuration 10)

A control system, including: a control device mounted on a vehicle; a vehicle control unit that controls a functional unit mounted on the vehicle; and a communication device that communicates with an external device of the vehicle, in which the control device includes a designation data acquisition unit that acquires designation data from the external device through the communication device, the designation data designating vehicle data that is subjected to collection processing, a designation data storage unit that stores the designation data, a vehicle data collection unit that executes the collection processing to collect the vehicle data designated by the designation data, from the vehicle, and a transmission control unit that transmits the vehicle data collected by the vehicle data collection unit, to the external device through a communication device.

The control device in the configuration 10 allows the external device to designate the content and type of vehicle data collected by the control device. This makes it possible to easily change the type and the number of vehicle data collected from the vehicle. Therefore, efficient collection of necessary data can be achieved in response to social situations or demands of data. This makes it possible to promote utilization of data relating to the vehicle and achieve, for example, improvement of energy efficiency.

### (Configuration 11)

A method of data collection by a control device mounted on a vehicle, including: acquiring designation data from an external device of the vehicle, the designation data designating vehicle data that is subjected to collection processing; storing the designation data in a designation data storage unit; executing the collection processing to collect the vehicle data designated by the designation data, from the vehicle; and transmitting the collected vehicle data to the external device through a communication device.

According to the method of data collection in configuration 11, the external device can designate the content and type of vehicle data collected by the control device of the vehicle. This makes it possible to easily change the type and the number of vehicle data collected from the vehicle. Therefore, efficient collection of necessary data can be achieved in response to social situations or demands of data. This makes it possible to promote utilization of data relating to the vehicle and achieve, for example, improvement of energy efficiency.

### REFERENCE SIGNS LIST

1 . . . Control system (control device), 2 . . . Central ECU, 12 . . . TCU (communication unit), 24 . . . Zone A-ECU, 29 . . . Zone B-ECU, 50 . . . Transfer table (designation data), 51 . . . Version information, 52 . . . Data List, 53 . . . Immediate transmission data list, 54 . . . Periodic transmission data list, 55 . . . Alternative transfer table (alternative designation data), 60, 60A, 60B . . . Target ECU (vehicle control unit), 100 . . . Data management system, 110 . . . Server (external device), 210 . . . Processor, 5211 . . . Acquisition unit (designation data acquisition unit), 212 . . . Vehicle data collection unit, 213 . . . Transmission control unit, 230 . . . RAM, 250 . . . Backup RAM (designation data storage unit), 270 . . . Non-volatile memory (alternative data storage unit), 271 . . . Control program, V . . . Vehicle

What is claimed is:

1. A control device mounted on a vehicle, comprising:
a designation data acquisition unit that acquires designation data from an external device of the vehicle, the designation data designating vehicle data that is subjected to collection processing;
a designation data storage unit that stores the designation data;
a vehicle data collection unit that executes the collection processing to collect the vehicle data designated by the designation data, from the vehicle; and
a transmission control unit that transmits the vehicle data collected by the vehicle data collection unit, to the external device through a communication device.

2. The control device according to claim 1, wherein
when the designation data is acquired from the external device, the designation data acquisition unit updates the designation data stored in the designation data storage unit, based on the acquired designation data.

3. The control device according to claim 2, wherein
when the designation data is acquired from the external device, the designation data acquisition unit compares the acquired designation data and the designation data stored in the designation data storage unit, and updates the designation data stored in the designation data storage unit, when the designation data acquired from the external device is newer.

4. The control device according to claim 1, wherein
when the vehicle detects a specific event, the designation data acquisition unit requests the external device to acquire the designation data corresponding to the specific event.

5. The control device according to claim 1, wherein
the designation data acquisition unit requests the external device to acquire the designation data, when trouble occurs in reading the designation data stored in the designation data storage unit.

6. The control device according to claim 1, comprising an alternative data storage unit that stores alternative designation data, the alternative designation data designating the vehicle data that is subjected to the collection processing, wherein
when trouble occurs in reading the designation data stored in the designation data storage unit, the designation data acquisition unit collects the vehicle data designated by the alternative designation data.

7. The control device according to claim 6, wherein
the designation data storage unit is a volatile storage unit that requires power supply for maintaining memory, and
the alternative data storage unit is a non-volatile storage unit.

8. The control device according to claim 1, wherein
in the collection processing, the vehicle data collection unit acquires the vehicle data from a vehicle control unit that controls a functional unit mounted on the vehicle, and
when processing load of the vehicle control unit is equal to or more than a predetermined load, the vehicle data collection unit does not acquire the vehicle data from the vehicle control unit.

9. The control device according to claim 1, wherein
in the collection processing, when the vehicle data collection unit acquires the vehicle data from a plurality of vehicle control units, out of the vehicle control units that each control a functional unit mounted on the vehicle, the vehicle data collection unit detects processing load of the plurality of vehicle control units, and acquires the vehicle data preferentially from the vehicle control unit with smaller processing load.

10. A control system, comprising:
a control device mounted on a vehicle;
a vehicle control unit that controls a functional unit mounted on the vehicle; and
a communication device that communicates with an external device of the vehicle, wherein
the control device comprises
a designation data acquisition unit that acquires designation data from the external device through the communication device, the designation data designating vehicle data that is subjected to collection processing,
a designation data storage unit that stores the designation data,
a vehicle data collection unit that executes the collection processing to collect the vehicle data designated by the designation data, from the vehicle, and
a transmission control unit that transmits, through a communication device, the vehicle data collected by the vehicle data collection unit, to the external device.

11. A method of data collection by a control device mounted on a vehicle, comprising:
acquiring designation data from an external device of the vehicle, the designation data designating vehicle data that is subjected to collection processing;
storing the designation data in a designation data storage unit;
executing the collection processing to collect the vehicle data designated by the designation data, from the vehicle; and
transmitting the collected vehicle data to the external device through a communication device.
